(19) United States
(12) Patent Application Publication
(10) Pub. No.: US 2025/0200116 A1
(43) Pub. Date: Jun. 19, 2025

(54) LABELING ASSISTANCE SYSTEM, LABELING ASSISTANCE METHOD, AND LABELING ASSISTANCE PROGRAM

(71) Applicant: NEC Corporation, Minato-ku, Tokyo (JP)

(72) Inventors: Noritaka Yamashita, Tokyo (JP); Takuroh Kashima, Tokyo (JP); Norihito Oi, Tokyo (JP); Asako Fujii, Tokyo (JP)

(73) Assignee: NEC Corporation, Minato-ku, Tokyo (JP)

(21) Appl. No.: 18/836,420

(22) PCT Filed: Mar. 2, 2022
(86) PCT No.: PCT/JP2022/008749

§ 371 Date: Aug. 7, 2024

(51) Int. Cl. G06F 16/906

(52) U.S. Cl. CPC G06F 16/906

(57) ABSTRACT

The first classification means 181 generates a first plurality of clusters by classifying a first data set, which is a data set to be labeled, through unsupervised learning. The second classification means 182 generates a second plurality of clusters by classifying a second data set, which is a data set containing at least some of the data to be labeled. The output means 183 outputs data included in the second plurality of clusters, which were classified into different clusters in the first plurality of clusters.

### TECHNICAL FIELD

The present invention relates to a labeling assistance system, a labeling assistance method, and a labeling assistance program for assisting labeling for unlabeled data.

### BACKGROUND ART

In the IoT (Internet of Things) society, it has become possible to collect data from various devices. On the other hand, for example, it is extremely difficult to find the desired video from a large amount of data through simple tasks. Therefore, a mechanism for searching collected data is required.

As a mechanism for searching data, a method of labeling the data can be mentioned. However, manually labeling a large amount of data requires enormous time and cost, so various methods for classifying data have been proposed.

For example, Patent Literature 1 describes a sensor data classification device that classifies sensor data obtained from numerous sensors based on their characteristics. The device described in Patent Literature 1 associates the set of sensor data divided into pre-set time intervals with sensor identifiers and division interval identifiers, and calculates multiple types of characteristic parameters from the data included in the divided data set.

### CITATION LIST

### Patent Literature

PL 1: Patent Publication No. 2016-99888

### SUMMARY OF INVENTION

### Technical Problem

For example, it is also conceivable to perform automatic labeling based on rules. However, the work of maintaining the rules according to changes in the environment, etc., is complicated, and the work of adding rules is also not easy.

In the device described in Patent Literature 1, the method of calculating the characteristic parameters for classification and the division intervals are pre-defined. However, even if data is classified based on numbers calculated according to some criteria, there is still the problem that meaningful labeling work for unlabeled data is costly.

Therefore, the purpose of the present invention is to provide a labeling assistance system, a labeling assistance method, and a labeling assistance program that can assist labeling work for clusters of classified unlabeled data.

### Solution to Problem

The labeling assistance system according to the present invention includes a first classification means for generating a first plurality of clusters by classifying a first data set, which is a data set to be labeled, through unsupervised learning, a second classification means for generating a second plurality of clusters by classifying a second data set, which is a data set containing at least some of the data to be labeled, and an output means for outputting data included in the second plurality of clusters, which were classified into different clusters in the first plurality of clusters.

The labeling assistance method includes: generating a first plurality of clusters by classifying a first data set, which is a data set to be labeled, through unsupervised learning, by a computer; generating a second plurality of clusters by classifying a second data set, which is a data set containing at least some of the data to be labeled, by the computer; and outputting data included in the second plurality of clusters, which were classified into different clusters in the first plurality of clusters, by the computer.

The labeling assistance program for causing a computer to execute: a first classification process of generating a first plurality of clusters by classifying a first data set, which is a data set to be labeled, through unsupervised learning; a second classification process of generating a second plurality of clusters by classifying a second data set, which is a data set containing at least some of the data to be labeled; and an output process of outputting data included in the second plurality of clusters, which were classified into different clusters in the first plurality of clusters.

### Advantageous Effects of Invention

According to the present invention, it is possible to assist labeling work for clusters of classified unlabeled data.

### BRIEF DESCRIPTION OF DRAWINGS

FIG. 1 It depicts a block diagram showing a configuration example of an example embodiment of the labeling assistance system according to the present invention.

FIG. 2 It depicts is an explanatory diagram showing an example of data used in the labeling assistance system.

FIG. 3 It depicts an explanatory diagram showing an example of features.

FIG. 4 It depicts an explanatory diagram showing an example of a graphical visualization of dimensionally reduced data.

FIG. 5 It depicts an explanatory diagram showing another example of a graphical visualization of dimensionally reduced data.

FIG. 6 It depicts an explanatory diagram showing an example of processing for labeling data within a cluster.

FIG. 7 It depicts an explanatory diagram showing an example of processing for selecting part of the clusters.

FIG. 8 It depicts an explanatory diagram showing an example of processing for excluding part of the data.

FIG. 9 It depicts an explanatory diagram showing an example of overlaying results before and after refinement.

FIG. 10 It depicts an explanatory diagram showing an example of displaying results before and after refinement in parallel windows.

FIG. 11 It depicts an explanatory diagram showing an example of displaying results before and after refinement in parallel windows.

FIG. 12 It depicts an explanatory diagram showing an example of listing data that yielded different results before and after refinement in a separate window.

FIG. 13 It depicts an explanatory diagram showing an example of overlaying multiple refinement results.

FIG. 14 It depicts an explanatory diagram showing an example of listing data that yielded different results in a separate window due to multiple refinements.

FIG. 15 It depicts an explanatory diagram showing an example of displaying statistical information of each cluster.

FIG. 16 It depicts an explanatory diagram showing another example of displaying statistical information of each cluster.

FIG. 17 It depicts a flowchart showing an operation example of the labeling assistance system according to the present invention.

FIG. 18 It depicts a block diagram showing an outline of the labeling assistance system according to the present invention.

FIG. 19 It depicts a schematic block diagram showing the configuration of a computer according to at least one example embodiment.

### DESCRIPTION OF EMBODIMENTS

Hereinafter, example embodiments of the present invention will be described with reference to the drawings. In the following description, video (video data) is exemplified as an example of unlabeled data. However, unlabeled data is not limited to videos, and may include, for example, still images, music data, text data, etc. Also, unlabeled data (data to be labeled) may be referred to as unclassified data hereinafter.

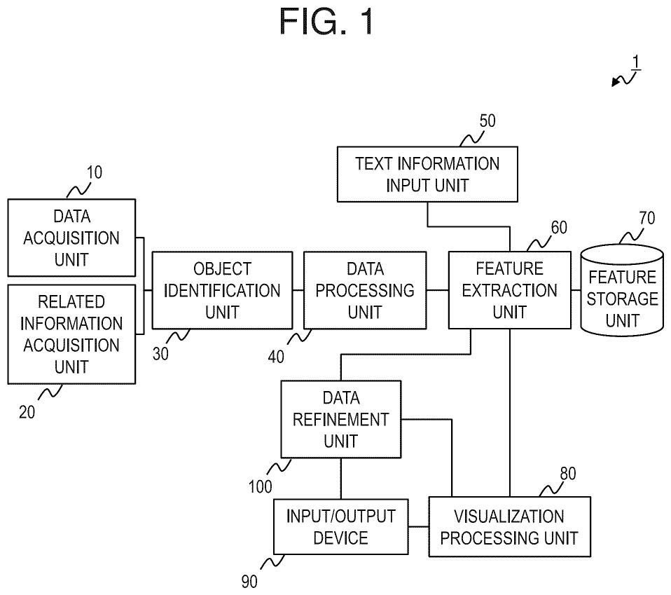

FIG. 1 is a block diagram showing a configuration example of an example embodiment of the labeling assistance system according to the present invention. The labeling assistance system 1 of this example embodiment includes a data acquisition unit 10, a related information acquisition unit 20, an object identification unit 30, a data processing unit 40, a text information input unit 50, a feature extraction unit 60, a feature storage unit 70, a visualization processing unit 80, an input/output device 90, and a data refinement unit 100.

The data acquisition unit 10 acquires data to be labeled (i.e., unclassified data). For example, when a vehicle being driven is imaged by a camera (not shown), the data acquisition unit 10 may acquire the video of the vehicle taken by the camera as the data to be labeled. Note that the data acquired by the data acquisition unit 10 is not limited to data acquired in real-time. The data acquisition unit 10 may, for example, acquire the data to be labeled from a storage server (not shown) where the data to be labeled is stored.

The related information acquisition unit 20 acquires information related to the data to be labeled (hereinafter referred to as related information). In this example embodiment, the related information is information indicating the situation in which the data to be labeled was generated, and includes, for example, information indicating the place where the data was generated (where the data was imaged) or the time, and data acquired by sensors (hereinafter referred to as sensor data).

For example, when the data to be labeled is video data imaged by an in-vehicle camera (drive recorder), the related information may include GPS (Global Positioning System) information indicating the vehicle position, and information acquired based on CAN (Controller Area Network). Examples of sensor data acquired in this case include speed, acceleration, position (latitude, longitude, altitude, etc.).

In addition, when video showing the operating status of a thermal power plant is used as the data to be labeled, sensor data such as fuel flow rate, pressure, temperature, rotation speed, power generation amount, etc., are mentioned. Other examples include when video showing the situation of a farm is used as the data to be labeled, sensor data such as time, temperature, humidity, pH, soil moisture content, solar radiation, wind direction and speed, water level, etc., are mentioned.

The object identification unit 30 identifies objects included in the acquired data and generates information (hereinafter referred to as an object list) specifying the identified objects. For example, when the object to be identified is a vehicle, the object identification unit 30 may identify the vehicle from the data acquired by the data acquisition unit 10 and generate information (e.g., coordinates indicating the position in the image, etc.) specifying the vehicle as an object list. The method for identifying objects from images or videos is widely known, and detailed descriptions are omitted here.

The data processing unit 40 processes the data (more specifically, the object list) into a form that can be used by the feature extraction unit 60 described later. Specifically, the data processing unit 40 processes the data to improve the accuracy of feature extraction and clustering. The data processing unit 40 may perform operations such as thinning the data, interpolating missing values, excluding outliers, and deleting unnecessary data items. For example, when the data to be labeled is video data, the data processing unit 40 may convert the video data into numerical time-series data.

The text information input unit 50 accepts input of text data containing information (hereinafter referred to as additional information) to be added to each data to be labeled. Additional information is information indicating the content of the data to be labeled that can be acquired in addition to the related information. Examples of categories indicating additional information include weather, plant types, and traffic participants. Examples of category values for weather include sunny, cloudy, rainy, snowy, etc., examples of category values for plant types include rice, wheat, barley, etc., and examples of traffic participants include automobiles, bicycles, pedestrians, etc.

Note that the input of text data is optional. In other words, additional information for the data to be labeled may not be input. However, it is preferable to input additional information because the more additional information is associated with the data to be labeled, the higher the classification accuracy can be improved. In the following description, data to be labeled associated with additional information will also be simply referred to as data to be labeled.

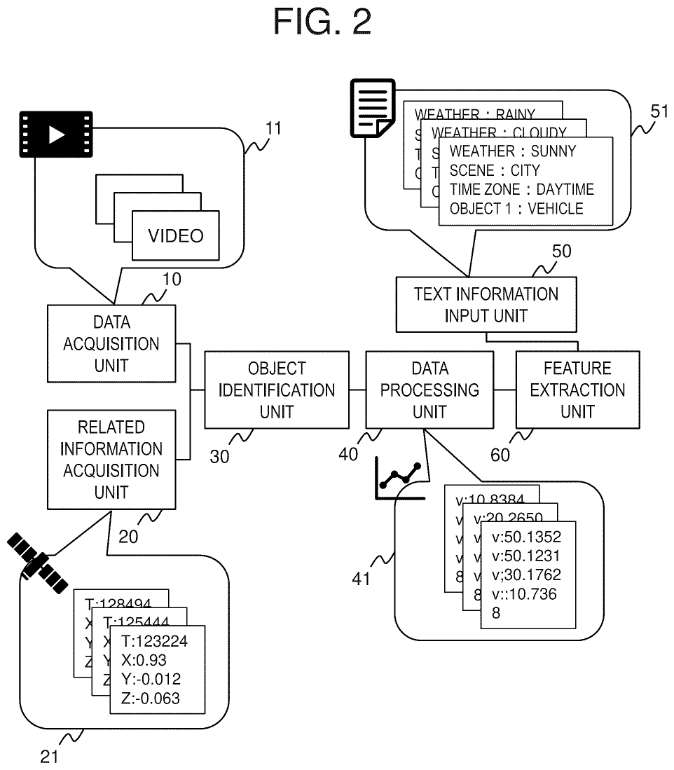

FIG. 2 is an explanatory diagram showing an example of data used in the labeling assistance system 1 of this example embodiment. In the example shown in FIG. 2, the data acquisition unit 10 acquires video 11 as the data to be labeled, and the related information acquisition unit 20 acquires related information 21 regarding the location where the video 11 was taken. In the example shown in FIG. 2, the data processing unit 40 processes the video 11 and related information 21 (more specifically, the object list generated by the object identification unit 30) and generates numerical time-series data 41. Furthermore, in the example shown in FIG. 2, the text information input unit 50 accepts input of text data 51 containing information regarding weather, scene, time zone, and objects as additional information.

The feature extraction unit 60 extracts features from each data to be labeled. The feature extraction unit 60 of this example embodiment first generates multiple clusters by automatically classifying each data to be labeled containing additional information through unsupervised learning. The method of generating clusters through unsupervised learning is arbitrary and may include methods such as k-means or Gaussian Mixture Models.

Hereinafter, the process of the feature extraction unit 60 classifying the data set to be labeled through unsupervised learning to generate multiple clusters is referred to as the first classification process. The multiple clusters generated by the first classification process are referred to as the first plurality of clusters, and the data set classified into the first plurality of clusters is referred to as the first data set. Also, since the feature extraction unit 60 classifies the data to be labeled through unsupervised learning, the feature extraction unit 60 can also be referred to as a classification means.

Then, the feature extraction unit 60 extracts the features of each data included in the generated clusters. The feature extraction unit 60 may extract the additional information included in the text data as features. In addition, the feature extraction unit 60 may extract the features indicated by the numerical time-series data. Specifically, the feature extraction unit 60 may extract features based on the sensor values included in the data to be labeled (more specifically, the numerical time-series data).

The method of extracting features from numerical time-series data is arbitrary. For example, the feature extraction unit 60 may extract features such as the distance from the centroid of the numerical time-series data included in each cluster to each data point (cluster distance feature) in clusters generated by the k-means method.

Furthermore, in this example embodiment, the object identification unit 30 identifies objects from the data acquired by the data acquisition unit 10 and the related information acquisition unit 20, and the data processing unit 40 processes the data into a form that can be used by the feature extraction unit 60. However, the data acquisition unit 10 may directly acquire data in a form that can be used by the feature extraction unit 60 and input the acquired data to the feature extraction unit 60. In this case, the labeling assistance system 1 may not include the related information acquisition unit 20, the object identification unit 30, and the data processing unit 40.

The feature storage unit 70 stores the features extracted by the feature extraction unit 60. Additionally, the feature storage unit 70 may store information on labels added by the data refinement unit 100 described later. The form in which the feature storage unit 70 stores the features for each data is arbitrary.

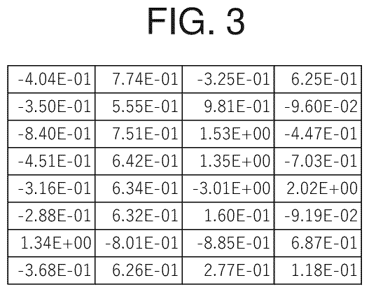

FIG. 3 is an explanatory diagram showing an example of the features stored by the feature storage unit 70. In the example shown in FIG. 3, the vertical direction represents one feature point, and the horizontal direction represents the features (category values) of each category (e.g., weather, traffic participants, plant types, etc.). The feature storage unit 70 is realized by, for example, a magnetic disk, etc.

The visualization processing unit 80 performs processing to visualize information contributing to the labeling work for the generated clusters. The visualization processing unit 80 of this example embodiment visualizes the reduced-dimension data (dimensional reduction) to be labeled by drawing a graph on the input/output device 90 to allow humans to observe how the data to be labeled is clustered.

The visualization processing unit 80 may reduce the dimensions of the data to be labeled to two or three dimensions by methods such as UMAP (Uniform Manifold Approximation and Projection), and visualize the reduced-dimension data as scatter plots or other graphs. At that time, the visualization processing unit 80 may display data classified into the same cluster in a different manner (e.g., changing colors, changing symbols, etc.) from other clusters.

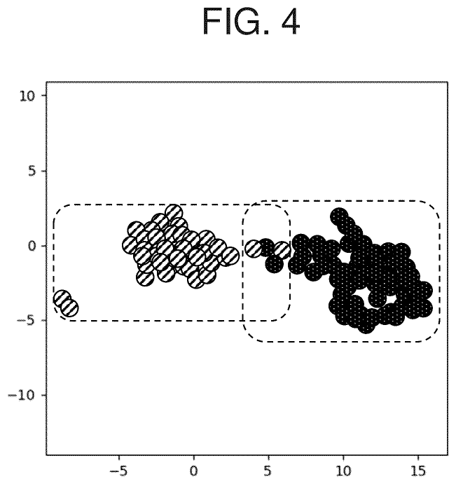

FIG. 4 is an explanatory diagram showing an example of a graphical visualization of dimensionally reduced data. The graph illustrated in FIG. 4 shows data reduced to two dimensions by UMAP and displayed with different patterns (e.g., diagonal lines, solid black, etc.) for each cluster.

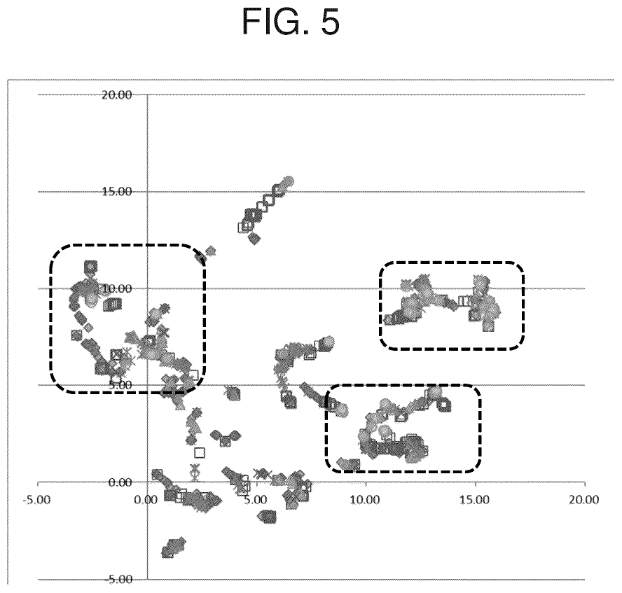

FIG. 5 is an explanatory diagram showing another example of a graphical visualization of dimensionally reduced data. The graph illustrated in FIG. 5 shows data plotted with different symbols for each type of video data. As illustrated in FIG. 5, the visualization processing unit 80 may display the range of data included in the clusters by enclosing the range with dotted lines to identify the clusters' ranges.

Furthermore, the visualization processing unit 80 may display all the data or decide whether to display only data that meets specific conditions or not. The visualization processing unit 80 may, for example, decide whether to display clusters that meet specific conditions (e.g., clusters with a number of data points exceeding a predetermined threshold) or unclassified data (i.e., data that has not been labeled).

Additionally, in this example embodiment, the visualization processing unit 80 outputs data that belongs to different clusters as a result of re-learning described later. The method of outputting the data will be described later.

The input/output device 90 displays the output results of the visualization processing unit 80. The input/output device 90 also accepts input from the user regarding the displayed results and performs processing based on the input. In this example embodiment, processing of the data refinement unit 100 described later is performed based on clusters specified by the user via the output of the input/output device 90.

The input/output device 90 may be realized by a tablet terminal, etc. In addition, the input/output device 90 may be realized by a device having a display device and a pointing device, etc.

The data refinement unit 100 executes various processes for the data set to be labeled based on the clusters generated by the feature extraction unit 60. Specifically, the data refinement unit 100 generates a second data set according to the generated first plurality of clusters from the data set to be labeled. In this example embodiment, a case will be described in which the data refinement unit 100 executes the following three types of processes.

First, the first process will be described. The first process is a process for labeling data within a cluster. In the first process, the data refinement unit 100 generates a second data set by labeling the data classified into one of the first plurality of clusters from the data set to be labeled, for each cluster. The clusters to be labeled by the data refinement unit 100 are arbitrary. The data refinement unit 100 may label all clusters or label only clusters specified by the user via the input/output device 90.

Furthermore, the content of the label to be added to the data within the cluster is arbitrary as long as the same label is added to the data within the cluster. The data refinement unit 100 may add arbitrary temporary labels to the data within the target clusters or add labels with content specified by the user. Then, the data refinement unit 100 may store the data (more specifically, the features of the data) and the added labels in the feature storage unit 70 in association with each other.

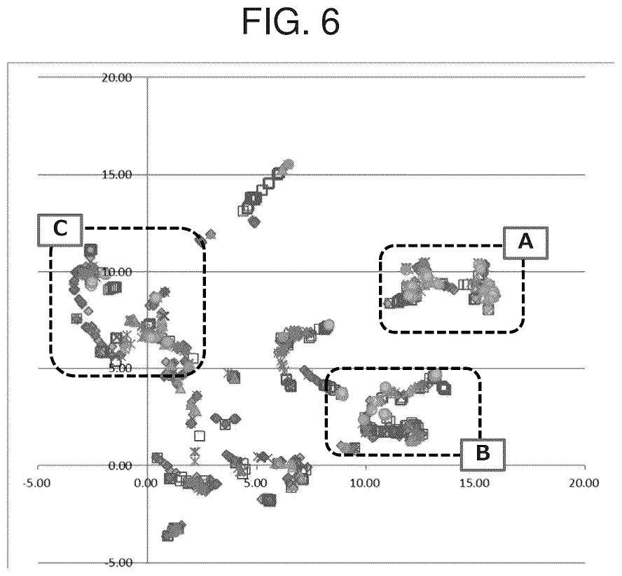

FIG. 6 is an explanatory diagram showing an example of processing for labeling data within a cluster. In the example shown in FIG. 6, the data refinement unit 100 adds temporary labels “A”, “B”, and “C” to the clusters illustrated in FIG. 5. Note that, when the target clusters to be labeled are specified by the user, the data refinement unit 100 may add temporary labels only to the specified clusters.

Subsequently, the feature extraction unit 60 generates multiple clusters again through supervised learning using the labeled data. The feature extraction unit 60 may perform learning (unsupervised learning), adding data without labels. Hereinafter, the process in which the feature extraction unit 60 generates multiple clusters by classifying a data set containing at least some of the data to be labeled is referred to as a second classification process. The multiple clusters generated by the second classification process are referred to as the second plurality of clusters, and the data set classified into the second plurality of clusters is referred to as the second data set.

Thus, since the second classification process generates multiple clusters again by re-learning using at least some of the data to be labeled used in the first classification process, the second classification process can be referred to as re-learning or refinement. This allows semi-automation of labeling through unsupervised learning and contributes to the discovery of new labels.

The feature extraction unit 60 may extract the features of each data included in the clusters (second plurality of clusters) generated by the second classification process and store the extracted features in the feature storage unit 70.

Then, after the second classification process, the visualization processing unit 80 outputs the data included in the second plurality of clusters, which were classified into different clusters in the first plurality of clusters. This corresponds to the process of visualizing data that belongs to different clusters as a result of re-learning. The specific process of visualization will be described later.

Next, the second process will be described. The second process is a process for selecting at least some of the clusters and re-learning through learning (unsupervised learning). The data refinement unit 100 generates, from the data set to be labeled, a data set classified into a cluster selected from the first plurality of clusters, as the second data set.

First, the data refinement unit 100 selects at least some of the clusters from the first plurality of clusters. The data refinement unit 100 may select clusters specified by the user via the input/output device 90 or automatically select clusters that meet certain conditions. The conditions are arbitrary and may include, for example, clusters with a number of data points exceeding a predetermined number, clusters with a percentage of classified data exceeding a predetermined threshold, etc. The data set classified into the selected clusters corresponds to the aforementioned second data set.

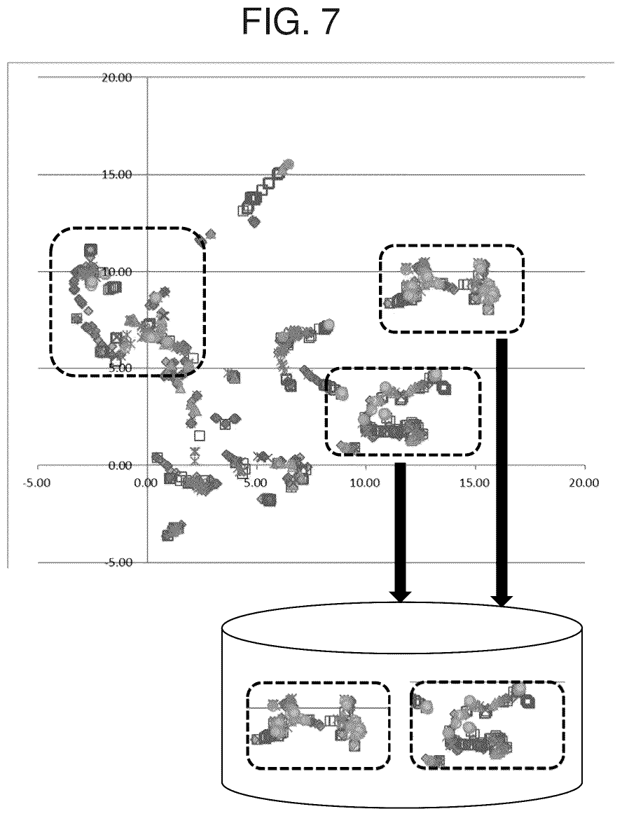

FIG. 7 is an explanatory diagram showing an example of processing for selecting part of the clusters. In the example shown in FIG. 7, two clusters are selected from the generated three clusters. Note that in the second process, the data refinement unit 100 may add arbitrary cluster identification information to the data within the clusters to identify the clusters classified by the first classification process.

Subsequently, the feature extraction unit 60 generates multiple clusters again through unsupervised learning using the data within the selected clusters (i.e., performs re-learning). This process corresponds to the aforementioned second classification process, and the generated multiple clusters correspond to the second plurality of clusters. The feature extraction unit 60 may add new data separately and perform learning. This allows for search of data within clusters and is expected to classify data in more detail.

Then, after the second classification process, the visualization processing unit 80 outputs the data included in the second plurality of clusters, which were classified into different clusters in the first plurality of clusters, similar to the first process. In addition, since there is a possibility that the selected cluster may be subdivided, the visualization processing unit 80 may output data in which the cluster identification information is in the minority among the data within the cluster (data that is not the maximum proportion) as data that was classified into different clusters in the first plurality of clusters.

Next, the third process will be described. The third process is a process for excluding at least some of the data that were not classified into any of the clusters and re-learning through unsupervised learning or supervised learning. The data refinement unit 100 generates a second data set by excluding one or more data points not classified into any of the first plurality of clusters from the data set to be labeled.

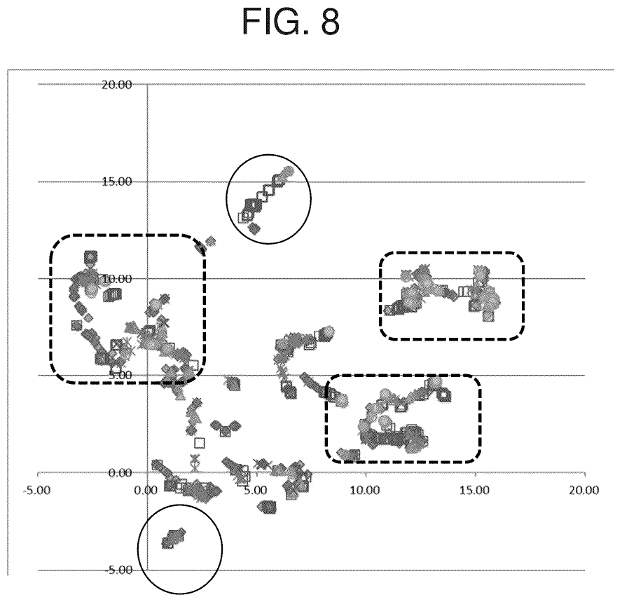

FIG. 8 is an explanatory diagram showing an example of processing for excluding part of the data. In the example shown in FIG. 8, data within the area surrounded by a solid circle is excluded as outliers. For example, when the data to be labeled is video data, the process corresponds to excluding noise scenes. Subsequently, at least one of the first process and the second process, or both, is performed. This improves the classification accuracy.

The three types of processes executed by the data refinement unit 100 have been described. However, the processes executed by the data refinement unit 100 are not limited to the three types of processes described above. The data refinement unit 100 may perform other data maintenance processes. Furthermore, after each process of the first process, the second process, and the third process, the same process or different processes may be performed again.

An example of the data maintenance process is the process of maintaining the data used for learning by the feature extraction unit 60. The data refinement unit 100 may output files containing labeled data sets or data sets with outliers excluded.

For example, in the first process described above, it is assumed that labeling was performed on the data set to be labeled. In this case, the data refinement unit 100 may create a label file with the specified labels, copy only the labeled data to the next learning folder, and distribute the original data to folders for each label based on the labels (move/copy).

For example, in the second process described above, it is assumed that clusters were selected. In this case, the data refinement unit 100 may create a data list file containing only the data belonging to the selected clusters and copy only the data belonging to the selected clusters to the next learning folder.

For example, in the third process described above, it is assumed that the process of excluding outliers was performed. In this case, the data refinement unit 100 may create a data list file containing only the data other than the specified data (outliers) and copy only the data other than the specified data (outliers) to the next learning folder.

Hereinafter, a specific method for visualizing the data that belongs to different clusters as a result of re-learning will be described. First, the visualization processing unit 80 reduces the dimensions of the data set to be labeled, and graphically draws the reduced-dimension data included in the first plurality of clusters and the reduced-dimension data included in the second plurality of clusters in a manner that allows identification by cluster. Then, the visualization processing unit 80 displays the reduced-dimension data included in the second plurality of clusters, which were classified into different clusters in the first plurality of clusters, in a different manner from other data.

Examples of different display manners include changing the shades of color, changing the color itself, changing the outline, and displaying it in a blinking manner.

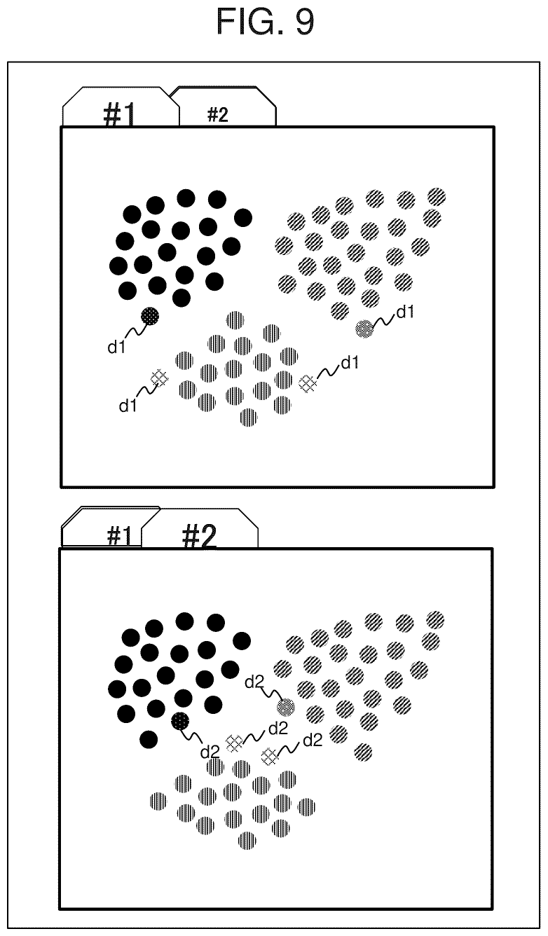

FIG. 9 is an explanatory diagram showing an example of overlaying results before and after refinement. In the example shown in FIG. 9, the visualization processing unit 80 displays the distribution of the data of each refinement overlaid and displays data other than the focused layer (i.e., refinement) in a different manner from the data of the focused layer. Specifically, in the example shown in FIG. 9, the results of the first refinement and the results of the second refinement are displayed overlaid. When focusing on the first refinement results, the data d1 included in the cluster only in the second refinement is displayed in a different manner from other data. Similarly, when focusing on the second refinement results, the data d2 included in the cluster only in the first refinement is displayed in a different manner from other data.

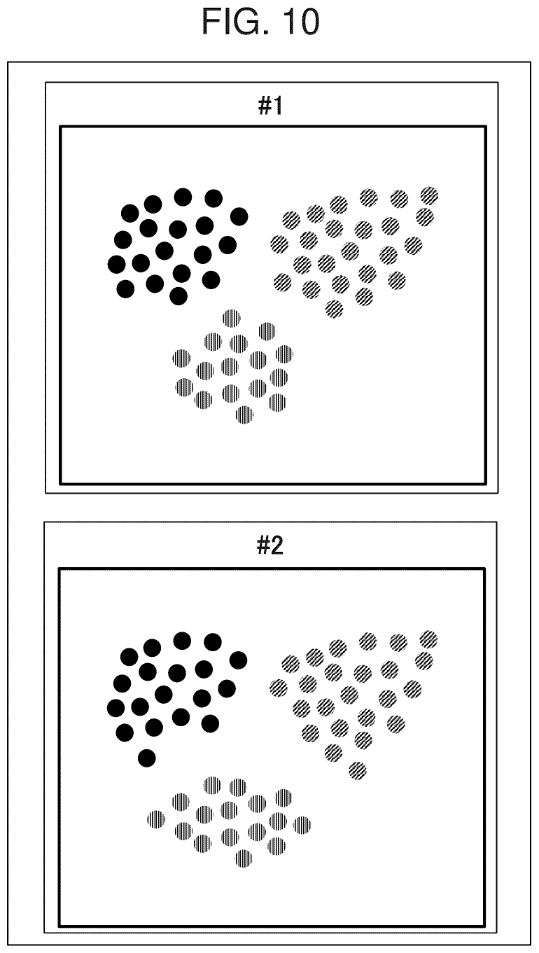

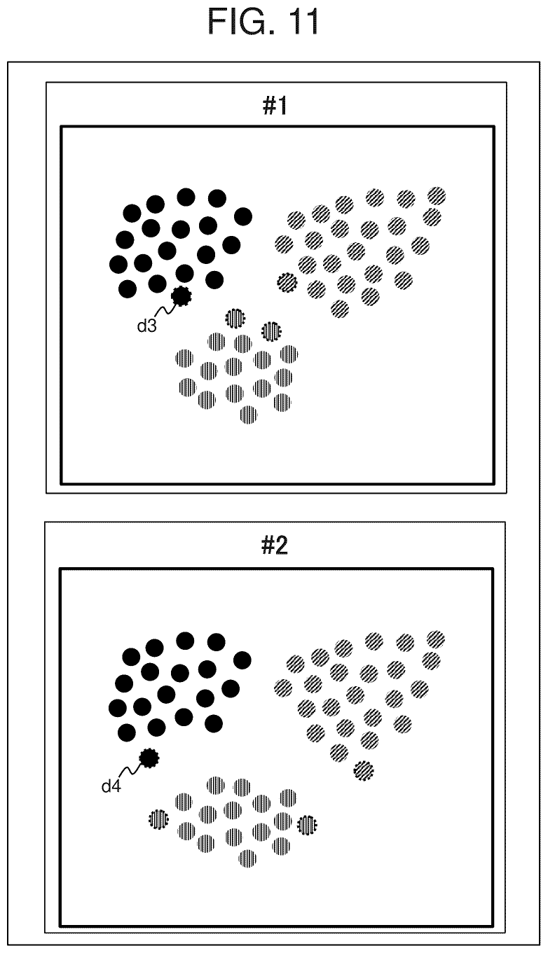

FIGS. 10 and 11 are explanatory diagrams showing examples of displaying results before and after refinement in parallel windows. As illustrated in FIG. 10, the visualization processing unit 80 may display the results before and after refinement in separate windows. At that time, as illustrated in FIG. 11, the visualization processing unit 80 may display the data that changed between the refinement before and after in a different manner from other data.

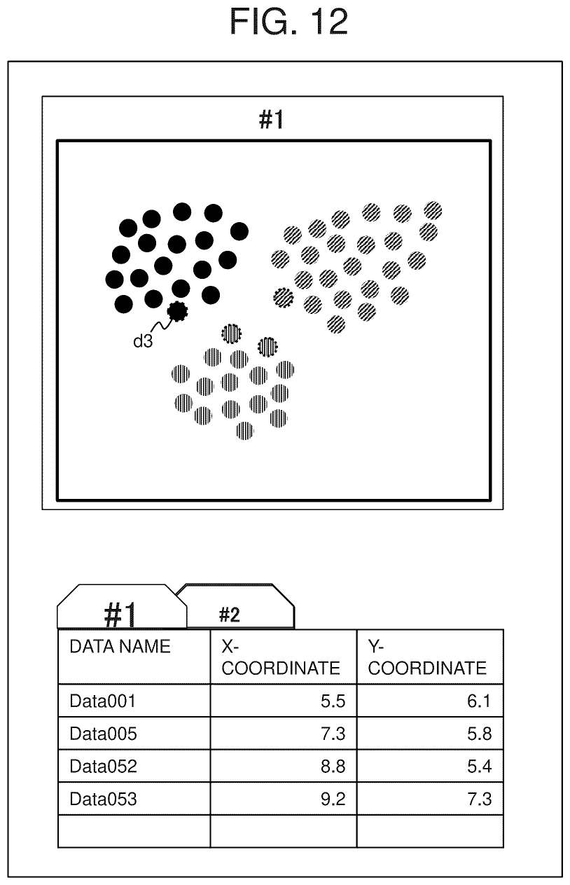

Furthermore, the visualization processing unit 80 may display a list of data with different results before and after refinement (i.e., data classified into different clusters). FIG. 12 is an explanatory diagram showing an example of listing the data d3 that yielded different results before and after refinement in a separate window. In the example shown in FIG. 12, the coordinates of the data that yielded different results before and after refinement are listed.

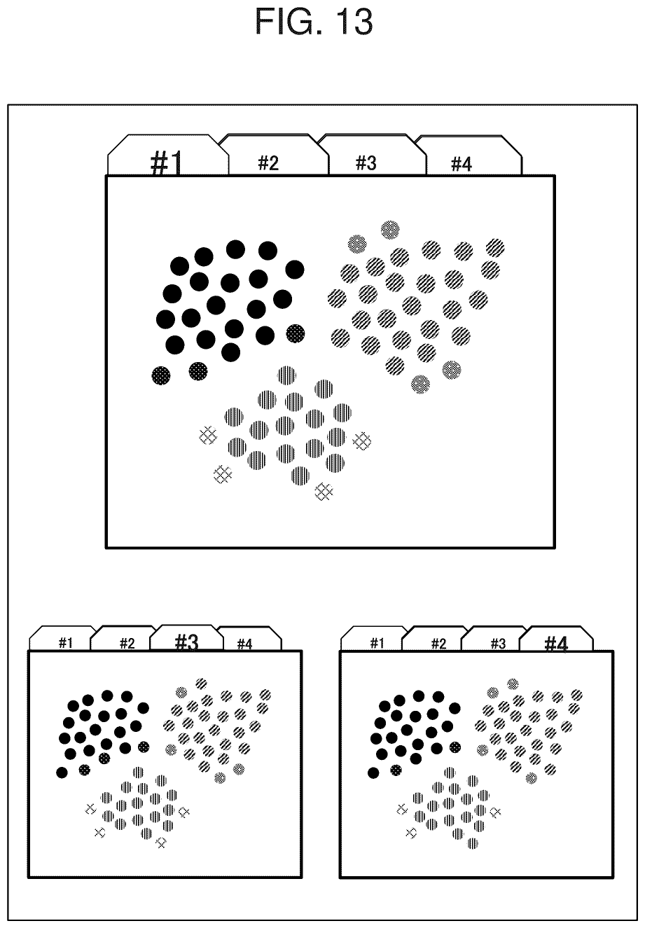

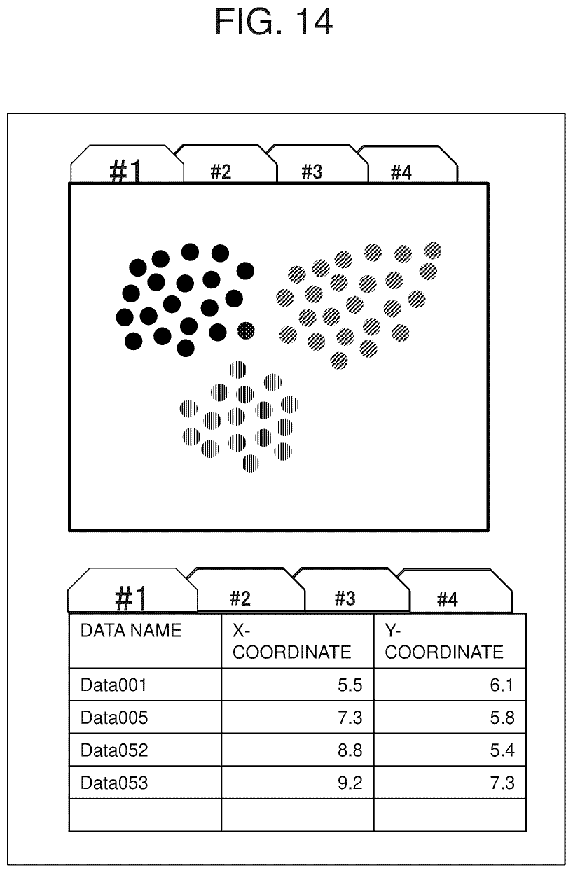

Note that FIGS. 9 to 12 show the case of comparing two refinement results. However, the comparison target is not limited to two results and may be three or more. FIG. 13 is an explanatory diagram showing an example of overlaying multiple refinement results. FIG. 14 is an explanatory diagram showing an example of listing data that yielded different results in a separate window due to multiple refinements. The example illustrated in FIG. 13 shows the case where four refinement results exist compared to the example illustrated in FIG. 9. Similarly, the example illustrated in FIG. 14 shows the case where four refinement results exist compared to the example illustrated in FIG. 12.

In addition, the visualization processing unit 80 may display statistical information of the clusters for each classification process (i.e., refinement) separately or together with the graphs described above. The creation of statistical information may be performed by the visualization processing unit 80 or the feature extraction unit 60.

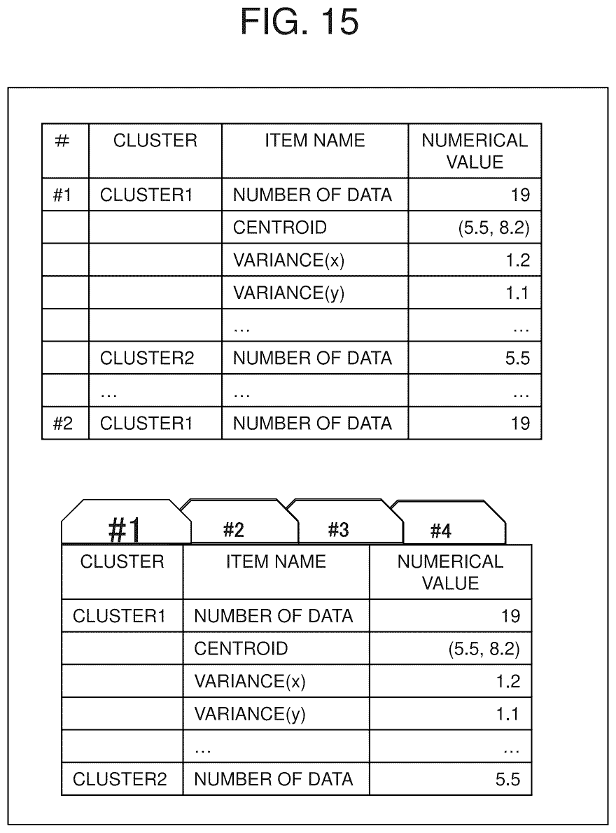

FIG. 15 is an explanatory diagram showing an example of displaying statistical information of each cluster. The example illustrated in FIG. 15 shows the number of data points within the cluster, the centroid of the data, and the variance (in the x direction and the y direction) as statistical information of the clusters. As illustrated in FIG. 15, the visualization processing unit 80 may display the statistical information for each refinement by switching between them or displaying them side by side.

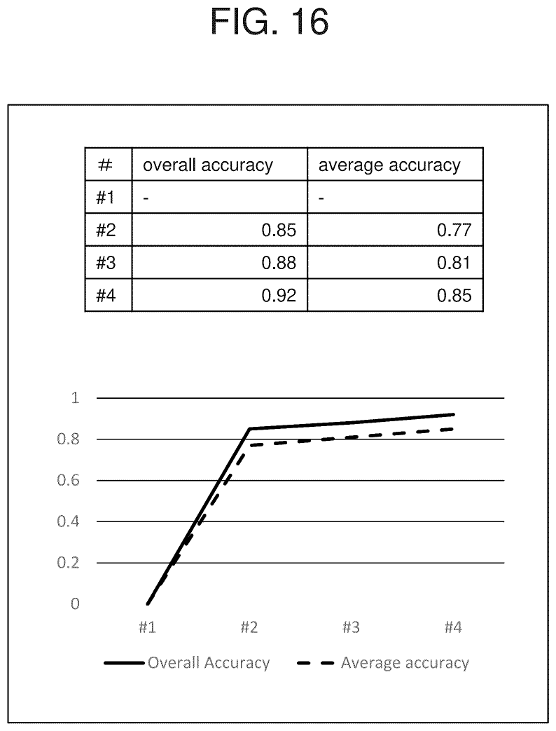

FIG. 16 is an explanatory diagram showing another example of displaying statistical information of each cluster. As illustrated in FIG. 16, the visualization processing unit 80 may display the statistical information of the clusters (e.g., false detection rate) in graph and table format. The example illustrated in FIG. 16 shows the consistency between the label and the cluster allocated when performing supervised learning. Note that in the example illustrated in FIG. 16, the first time assumes unsupervised learning, so there is no evaluation result.

The data acquisition unit 10, the related information acquisition unit 20, the object identification unit 30, the data processing unit 40, the text information input unit 50, the feature extraction unit 60, the visualization processing unit 80, and the data refinement unit 100 are realized by a processor (e.g., CPU (Central Processing Unit)) of a computer operating according to a program (labeling assistance program).

For example, the program is stored in a storage unit (not shown) of the labeling assistance system 1, and the processor may read the program and operate according to the program as the data acquisition unit 10, the related information acquisition unit 20, the object identification unit 30, the data processing unit 40, the text information input unit 50, the feature extraction unit 60, the visualization processing unit 80, and the data refinement unit 100. Also, the functions of the labeling assistance system 1 may be provided in the form of SaaS (Software as a Service).

The data acquisition unit 10, the related information acquisition unit 20, the object identification unit 30, the data processing unit 40, the text information input unit 50, the feature extraction unit 60, the visualization processing unit 80, and the data refinement unit 100 may be realized by dedicated hardware. Additionally, some or all of the components of each device may be realized by general-purpose or dedicated circuits, processors, etc., or combinations thereof. These may be configured by a single chip or by multiple chips connected via a bus. Some or all of the components of each device may be realized by a combination of the aforementioned circuits and programs.

Furthermore, when some or all of the components of the labeling assistance system 1 are realized by multiple information processing devices or circuits, the multiple information processing devices or circuits may be centrally located or distributed. For example, the information processing devices or circuits may be realized in a form connected via a communication network, such as a client-server system or a cloud computing system.

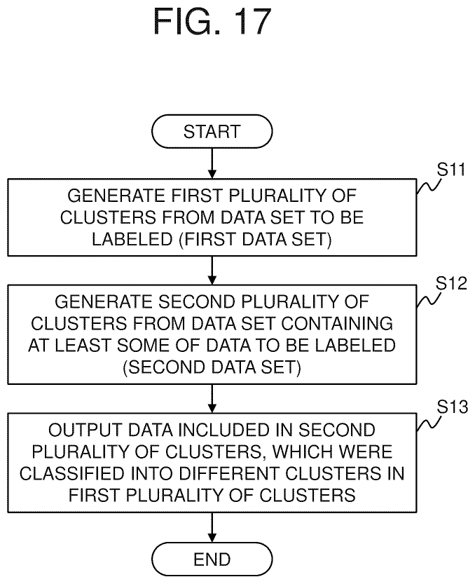

Next, the operation of the labeling assistance system 1 of this example embodiment will be described. FIG. 17 is a flowchart showing an operation example of the labeling assistance system 1. The operation example illustrated in FIG. 17 shows the case where the data acquisition unit 10 directly acquires data in a form used by the feature extraction unit 60 and inputs the acquired data to the feature extraction unit 60.

The feature extraction unit 60 generates a first plurality of clusters from the data set to be labeled (the first data set) (step S11). Subsequently, the feature extraction unit 60 generates a second plurality of clusters from a data set containing at least some of the data to be labeled (the second data set) (step S12). Then, the visualization processing unit 80 outputs the data included in the second plurality of clusters, which were classified into different clusters in the first plurality of clusters (step S13).

As described above, in this example embodiment, the feature extraction unit 60 generates a first plurality of clusters by classifying the first data set through unsupervised learning. Furthermore, the feature extraction unit 60 generates a second plurality of clusters by classifying the second data set. Then, the visualization processing unit 80 outputs the data included in the second plurality of clusters, which were classified into different clusters in the first plurality of clusters. Therefore, it is possible to assist labeling work for clusters of classified unlabeled data.

Furthermore, in this example embodiment, the data refinement unit 100 generates a second data set according to the generated first plurality of clusters from the data set to be labeled. Therefore, it is possible to improve the accuracy of re-learning using the generated second data set.

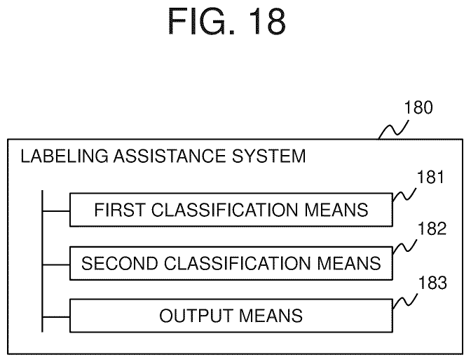

Next, the outline of the present invention will be described. FIG. 18 is a block diagram showing an outline of the labeling assistance system according to the present invention. The labeling assistance system 180 (e.g., the labeling assistance system 1) according to the present invention includes a first classification means 181 (e.g., the feature extraction unit 60) for generating a first plurality of clusters by classifying a first data set, which is a data set to be labeled, through unsupervised learning, a second classification means 182 (e.g., the feature extraction unit 60) for generating a second plurality of clusters by classifying a second data set, which is a data set containing at least some of the data to be labeled (e.g., through re-learning), and an output means 183 (e.g., the visualization processing unit 80) for outputting data included in the second plurality of clusters, which were classified into different clusters in the first plurality of clusters.

With such a configuration, it is possible to assist labeling work for clusters of classified unlabeled data.

Furthermore, the labeling assistance system 180 may include a data refinement means (e.g., the data refinement unit 100) for generating the second data set according to the generated first plurality of clusters from the data set to be labeled.

Specifically, the data refinement means may generate the second data set by performing labeling for each cluster on data classified into one of the first plurality of clusters from the data set to be labeled (e.g., the first process by the data refinement unit 100 described above).

Furthermore, the data refinement means may generate, from the data set to be labeled, a data set classified into a cluster selected from the first plurality of clusters, as the second data set (e.g., the second process by the data refinement unit 100 described above).

Furthermore, the data refinement means may generate, from the data set to be labeled, the second data set by excluding one or more pieces of data that are not classified into any of the first plurality of clusters (e.g., the third process by the data refinement unit 100 described above).

Furthermore, the output means may reduce the dimensions of the data set to be labeled, graphically draw the reduced-dimension data included in the first plurality of clusters and the reduced-dimension data included in the second plurality of clusters in a manner that allows identification by cluster, and display the reduced-dimension data included in the second plurality of clusters, which were classified into different clusters in the first plurality of clusters, in a different manner from other data.

Furthermore, the output means may display statistical information of the clusters for each classification process.

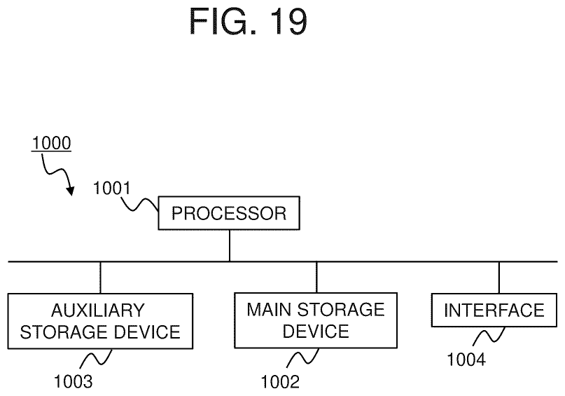

FIG. 19 is a schematic block diagram showing the configuration of a computer according to at least one example embodiment. The computer 1000 includes a processor 1001, a main memory 1002, an auxiliary memory 1003, and an interface 1004.

The labeling assistance system 180 described above is implemented in the computer 1000. The operations of each processing unit described above are stored in the auxiliary memory 1003 in the form of a program (labeling assistance program). The processor 1001 reads the program from the auxiliary memory 1003, expands it into the main memory 1002, and executes the above processing according to the program.

Note that the auxiliary memory 1003 in at least one example embodiment is an example of a non-transitory tangible medium. Other examples of non-transitory tangible media include magnetic disks, magneto-optical disks, CD-ROMs (Compact Disc Read-Only Memory), DVD-ROMs (Digital Versatile Disc Read-Only Memory), semiconductor memories, etc., connected via the interface 1004. Furthermore, when this program is delivered to the computer 1000 via a communication line, the computer 1000 may expand the delivered program into the main memory 1002 and execute the above processing.

Furthermore, this program may be intended to realize only part of the functions described above. Moreover, this program may be a so-called differential file (differential program) realized in combination with other programs already stored in the auxiliary memory 1003 that realize the functions described above.

A part of or all of the above example embodiments may also be described as, but not limited to, the following supplementary notes.

(Supplementary note 1) A labeling assistance system comprising:
a first classification means for generating a first plurality of clusters by classifying a first data set, which is a data set to be labeled, through unsupervised learning;
a second classification means for generating a second plurality of clusters by classifying a second data set, which is a data set containing at least some of the data to be labeled; and
an output means for outputting data included in the second plurality of clusters, which were classified into different clusters in the first plurality of clusters.

(Supplementary note 2) The labeling assistance system according to Supplementary note 1, further comprising
a data refinement means for generating the second data set according to the generated first plurality of clusters from the data set to be labeled.

(Supplementary note 3) The labeling assistance system according to Supplementary note 1 or 2, wherein
the data refinement means generates the second data set by performing labeling for each cluster on data classified into one of the first plurality of clusters from the data set to be labeled.

(Supplementary note 4) The labeling assistance system according to Supplementary note 1 or 2, wherein
the data refinement means generates, from the data set to be labeled, a data set classified into a cluster selected from the first plurality of clusters, as the second data set.

(Supplementary note 5) The labeling assistance system according to any one of Supplementary notes 1 to 4, wherein
the data refinement means generates, from the data set to be labeled, the second data set by excluding one or more pieces of data that are not classified into any of the first plurality of clusters.

(Supplementary note 6) The labeling assistance system according to any one of Supplementary notes 1 to 5, wherein
the output means reduces the dimensions of the data set to be labeled, graphically draws the reduced-dimension data included in the first plurality of clusters and the reduced-dimension data included in the second plurality of clusters in a manner that allows identification by cluster, and displays the reduced-dimension data included in the second plurality of clusters, which were classified into different clusters in the first plurality of clusters, in a different manner from other data.

(Supplementary note 7) The labeling assistance system according to any one of Supplementary notes 1 to 6, wherein
the output means displays statistical information of the clusters for each classification process.

(Supplementary note 8) A labeling assistance method comprising:
generating a first plurality of clusters by classifying a first data set, which is a data set to be labeled, through unsupervised learning, by a computer;
generating a second plurality of clusters by classifying a second data set, which is a data set containing at least some of the data to be labeled, by the computer; and
outputting data included in the second plurality of clusters, which were classified into different clusters in the first plurality of clusters, by the computer.

(Supplementary note 9) The labeling assistance method according to Supplementary note 8, further comprising
generating the second data set according to the generated first plurality of clusters from the data set to be labeled.

(Supplementary note 10) A program storage medium storing a labeling assistance program for causing a computer to execute:
a first classification process of generating a first plurality of clusters by classifying a first data set, which is a data set to be labeled, through unsupervised learning;
a second classification process of generating a second plurality of clusters by classifying a second data set, which is a data set containing at least some of the data to be labeled; and
an output process of outputting data included in the second plurality of clusters, which were classified into different clusters in the first plurality of clusters.

(Supplementary note 11) The program storage medium according to Supplementary note 10, storing the labeling assistance program for causing a computer to execute a data refinement process of generating the second data set according to the generated first plurality of clusters from the data set to be labeled.

(Supplementary note 12) An assistance program for causing a computer to execute:
a first classification process of generating a first plurality of clusters by classifying a first data set, which is a data set to be labeled, through unsupervised learning;
a second classification process of generating a second plurality of clusters by classifying a second data set, which is a data set containing at least some of the data to be labeled; and
an output process of outputting data included in the second plurality of clusters, which were classified into different clusters in the first plurality of clusters.

(Supplementary note 13) The assistance program according to Supplementary note 12, for causing a computer to execute a data refinement process of generating the second data set according to the generated first plurality of clusters from the data set to be labeled.

The above description of the present invention is with reference to the example embodiments, but the present invention is not limited to the above example embodiments. Various changes can be made to the composition and details of the present invention that can be understood by those skilled in the art within the scope of the present invention.

### REFERENCE SIGNS LIST

1 Labeling assistance system
10 Data acquisition unit
20 Related information acquisition unit
30 Object identification unit
40 Data processing unit
50 Text information input unit
60 Feature extraction unit
70 Feature storage unit
80 Visualization processing unit
90 Input/output device
100 Data refinement unit

What is claimed is:

1. A labeling assistance system comprising:
a memory storing instructions; and
one or more processors configured to execute the instructions to:
generate a first plurality of clusters by classifying a first data set, which is a data set to be labeled, through unsupervised learning;
generate a second plurality of clusters by classifying a second data set, which is a data set containing at least some of the data to be labeled; and
output data included in the second plurality of clusters, which were classified into different clusters in the first plurality of clusters.

2. The labeling assistance system according to claim 1, wherein the processor is configured to execute the instructions to
generate the second data set according to the generated first plurality of clusters from the data set to be labeled.

3. The labeling assistance system according to claim 2, wherein the processor is configured to execute the instructions to
generate the second data set by performing labeling for each cluster on data classified into one of the first plurality of clusters from the data set to be labeled.

4. The labeling assistance system according to claim 1, wherein the processor is configured to execute the instructions to
generate, from the data set to be labeled, a data set classified into a cluster selected from the first plurality of clusters, as the second data set.

5. The labeling assistance system according to claim 1, wherein the processor is configured to execute the instructions to
generate, from the data set to be labeled, the second data set by excluding one or more pieces of data that are not classified into any of the first plurality of clusters.

6. The labeling assistance system according to claim 1, wherein the processor is configured to execute the instructions to
reduce the dimensions of the data set to be labeled, graphically draw the reduced-dimension data included in the first plurality of clusters and the reduced-dimension data included in the second plurality of clusters in a manner that allows identification by cluster, and display the reduced-dimension data included in the second plurality of clusters, which were classified into different clusters in the first plurality of clusters, in a different manner from other data.

7. The labeling assistance system according to claim 1, wherein the processor is configured to execute the instructions to
display statistical information of the clusters for each classification process.

8. A labeling assistance method comprising:
generating a first plurality of clusters by classifying a first data set, which is a data set to be labeled, through unsupervised learning, by a computer,
generating a second plurality of clusters by classifying a second data set, which is a data set containing at least some of the data to be labeled, by the computer; and
outputting data included in the second plurality of clusters, which were classified into different clusters in the first plurality of clusters, by the computer.

9. The labeling assistance method according to claim 8, further comprising
generating the second data set according to the generated first plurality of clusters from the data set to be labeled.

10. A non-transitory computer readable information recording medium storing a labeling assistance program, when executed by a processor, that performs a method for:
generating a first plurality of clusters by classifying a first data set, which is a data set to be labeled, through unsupervised learning;
generating a second plurality of clusters by classifying a second data set, which is a data set containing at least some of the data to be labeled; and
outputting data included in the second plurality of clusters, which were classified into different clusters in the first plurality of clusters.

11. The non-transitory computer readable information recording medium according to claim 10, further generating the second data set according to the generated first plurality of clusters from the data set to be labeled.
